(19) United States
(12) Patent Application Publication
(10) Pub. No.: US 2017/0026876 A1
(43) Pub. Date: Jan. 26, 2017

(54) TUNE AWAY PROCEDURE BASED ON TDD UPLINK/DOWNLINK CONFIGURATION

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/804,307

(22) Filed: Jul. 20, 2015

(51) Int. Cl. H04W 36/00; H04W 72/04; H04L 5/14; H04W 74/00

(52) U.S. Cl. CPC H04W 36/0016; H04W 74/002; H04W 72/0406; H04L 5/14; H04W 88/02

(57) ABSTRACT

A method and system for wireless communication in a time division duplex (TDD) system in a multi-SIM (subscriber identity module) multi-standby, single receiver UE (user equipment), adjusts a tune away procedure based on a current time division duplexing (TDD) uplink/downlink configuration and/or number of active component carrier of carrier aggregation. The UE (user equipment) determines when to start a tune away from a first RAT (radio access technology) to a second RAT (radio access technology) based, at least in part, on a current TDD (time division duplexing) uplink/downlink configuration of the first RAT (radio access technology).

### BACKGROUND

Field

Aspects of the present disclosure relate generally to wireless communication systems, and more particularly, to adjust a tune away procedure based on a current time division duplexing (TDD) uplink/downlink configuration and/or number of active component carrier of carrier aggregation.

Background

Wireless communication networks are widely deployed to provide various communication services, such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, there exists a need for further improvements in wireless technology. Preferably, these improvements should be applicable to LTE and other multi-access technologies and the telecommunication standards that employ these technologies.

### SUMMARY

In one aspect, a method of wireless communication in a time division duplex (TDD) system in a multi-SIM (subscriber identity module) multi-standby, single receiver UE (user equipment) is disclosed. The method includes determining, at the UE, when to start a tune away from a first RAT (radio access technology) to a second RAT. The determining is based, at least in part, on a current TDD uplink/downlink configuration of the first RAT.

Another aspect discloses an apparatus for wireless communication in a time division duplex (TDD) system in a multi-SIM (subscriber identity module) multi-standby, single receiver apparatus. The apparatus includes means for determining, at the apparatus, when to start a tune away from a first RAT (radio access technology) to a second RAT based, at least in part, on a current TDD uplink/downlink configuration of the first RAT. The apparatus also includes means for starting the tune away in accordance with the determining.

Another aspect discloses an apparatus for wireless communication in a time division duplex (TDD) system in a multi-SIM (subscriber identity module) multi-standby, single receiver UE (user equipment). The apparatus has a memory, a transceiver configured for wireless communication, and at least one processor coupled to the memory. The processor(s) is configured to determine, at the apparatus, when to start a tune away from a first RAT (radio access technology) to a second RAT based, at least in part, on a current TDD uplink/downlink configuration of the first RAT.

In another aspect, a computer program product for wireless communications in a in a time division duplex (TDD) system in a multi-SIM (subscriber identity module) multi-standby, single receiver UE (user equipment) having a non-transitory computer-readable medium is disclosed. The computer readable medium has non-transitory program code recorded thereon which, when executed by the processor(s), causes the processor(s) to perform operation of determining, at the apparatus, when to start a tune away from a first RAT (radio access technology) to a second RAT based, at least in part, on a current TDD uplink/downlink configuration of the first RAT.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture.

FIG. 2 is a diagram illustrating an example of a downlink frame structure in long term evolution (LTE).

FIG. 3 is a diagram illustrating an example of an uplink frame structure in long term evolution (LTE).

FIG. 4 is a block diagram conceptually illustrating an example of a telecommunications system employing a time division synchronous code division multiple access (TD-SCDMA) standard.

FIG. 5 is a block diagram conceptually illustrating an example of a frame structure for a time division synchronous code division multiple access carrier.

FIG. 6 is a block diagram conceptually illustrating an example of a base station in communication with a user equipment (UE) in a telecommunications system.

FIG. 7 is a diagram illustrating network coverage areas according to aspects of the present disclosure.

FIG. 8 illustrates TDD LTE uplink/downlink subframe configurations according to aspects of the present disclosure.

FIG. 9 is a flow diagram illustrating a method for scheduling a tune away according to one aspect of the present disclosure.

FIG. 10 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

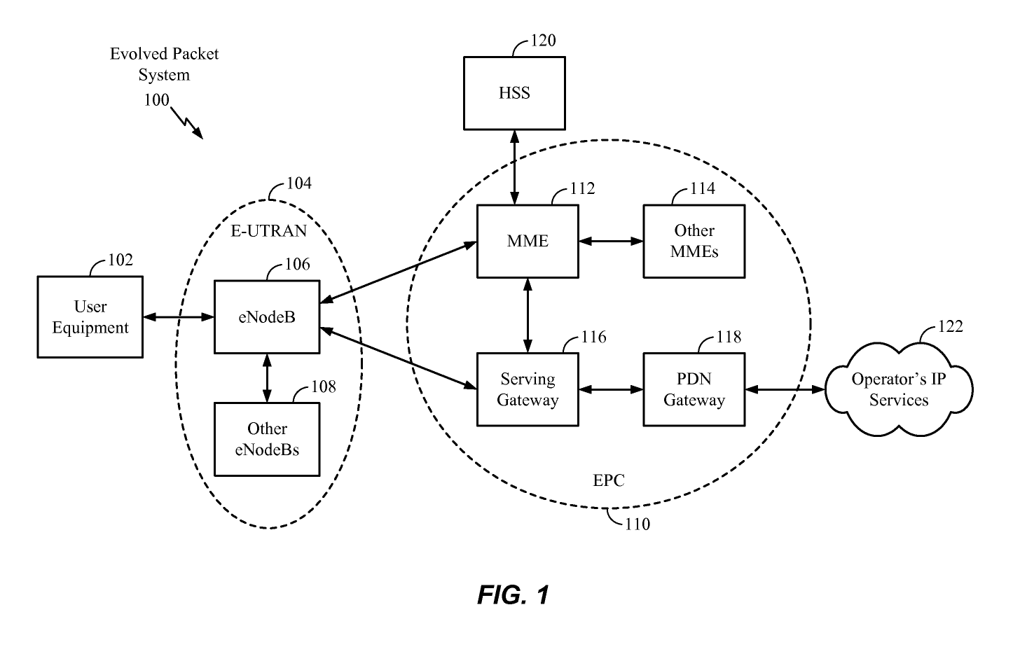

FIG. 1 is a diagram illustrating an network architecture 100 of a long term evolution (LTE) network. The LTE network architecture 100 may be referred to as an evolved packet system (EPS) 100. The EPS 100 may include one or more user equipment (UE) 102, an evolved UMTS terrestrial radio access network (E-UTRAN) 104, an evolved packet core (EPC) 110, a home subscriber server (HSS) 120, and an operator's IP services 122. The EPS can interconnect with other access networks, but for simplicity those entities/interfaces are not shown. As shown, the EPS 100 provides packet-switched services, however, as those skilled in the art will readily appreciate, the various concepts presented throughout this disclosure may be extended to networks providing circuit-switched services.

The E-UTRAN 104 includes an evolved NodeB (eNB) 106 and other eNBs 108. The eNB 106 provides user and control plane protocol terminations toward the UE 102. The eNB 106 may be connected to the other eNBs 108 via a backhaul (e.g., an X2 interface). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a notebook, a netbook, a smartbook, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station or apparatus, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110 via, e.g., an S1 interface. The EPC 110 includes a mobility management entity (MME) 112, other MMEs 114, a serving gateway 116, and a packet data network (PDN) gateway 118. The MME 112 is the control node that processes the signaling between the UE 102 and the EPC 110. Generally, the MME 112 provides bearer and connection management. All user IP packets are transferred through the serving gateway 116, which itself is connected to the PDN gateway 118. The PDN gateway 118 provides UE IP address allocation as well as other functions. The PDN gateway 118 is connected to the operator's IP services 122. The operator's IP services 122 may include the Internet, the Intranet, an IP multimedia subsystem (IMS), and a PS streaming service (PSS).

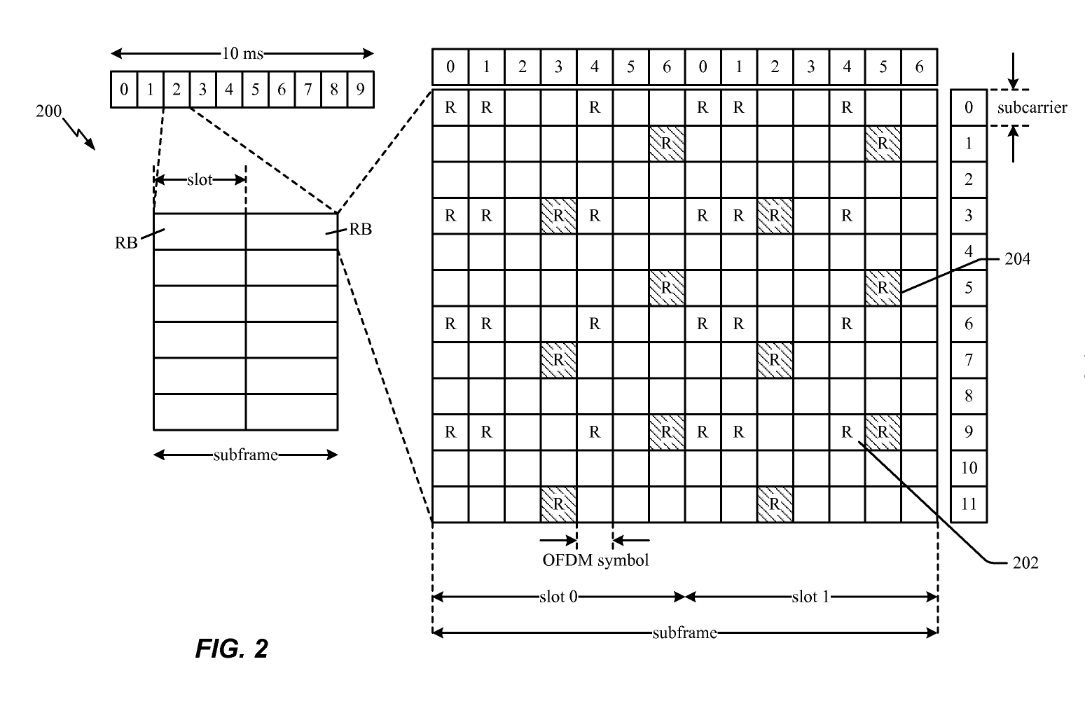

FIG. 2 is a diagram 200 illustrating an example of a downlink frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 202, 204, include downlink reference signals (DL-RS). The DL-RS include Cell-specific RS (CRS) (also sometimes called common RS) 202 and UE-specific RS (UE-RS) 204. UE-RS 204 are transmitted only on the resource blocks upon which the corresponding physical downlink shared channel (PDSCH) is mapped. The number of bits carried by each resource element depends on the modulation scheme. Thus, the more resource blocks that a UE receives and the higher the modulation scheme, the higher the data rate for the UE.

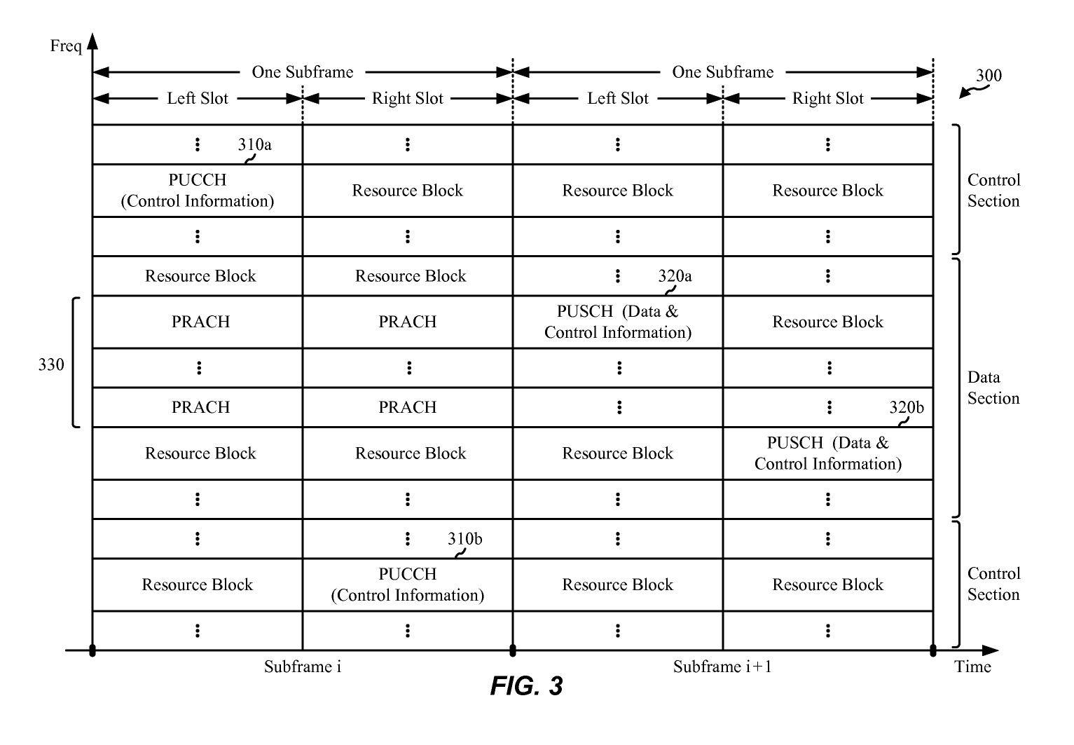

FIG. 3 is a diagram 300 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 310a, 310b in the control section to transmit control information to an eNB. The UE may also be assigned resource blocks 320a, 320b in the data section to transmit data to the eNB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. An uplink transmission may span both slots of a subframe and may hop across frequency.

A set of resource blocks may be used to perform initial system access and achieve uplink synchronization in a physical random access channel (PRACH) 330. The PRACH 330 carries a random sequence and cannot carry any uplink data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

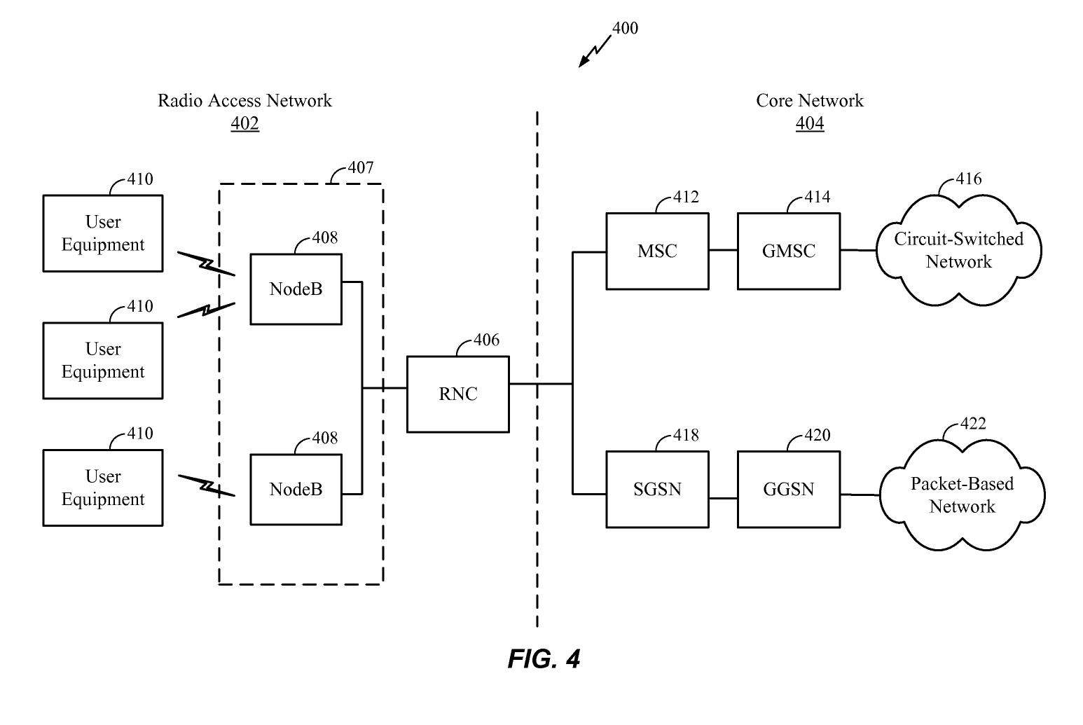

Turning now to FIG. 4, a block diagram is shown illustrating an example of a telecommunications system 400. The various concepts presented throughout this disclosure may be implemented across a broad variety of telecommunication systems, network architectures, and communication standards. By way of example and without limitation, the aspects of the present disclosure illustrated in FIG. 4 are presented with reference to a UMTS system employing a TD-SCDMA standard. In this example, the UMTS system includes a radio access network (RAN) 402 (e.g., UTRAN) that provides various wireless services including telephony, video, data, messaging, broadcasts, and/or other services. The RAN 402 may be divided into a number of radio network subsystems (RNSs) such as an RNS 407, each controlled by a radio network controller (RNC), such as an RNC 406. For clarity, only the RNC 406 and the RNS 407 are shown; however, the RAN 402 may include any number of RNCs and RNSs in addition to the RNC 406 and RNS 407. The RNC 406 is an apparatus responsible for, among other things, assigning, reconfiguring and releasing radio resources within the RNS 407. The RNC 406 may be interconnected to other RNCs (not shown) in the RAN 402 through various types of interfaces such as a direct physical connection, a virtual network, or the like, using any suitable transport network.

The geographic region covered by the RNS 407 may be divided into a number of cells, with a radio transceiver apparatus serving each cell. A radio transceiver apparatus is commonly referred to as a nodeB in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two nodeBs 408 are shown; however, the RNS 407 may include any number of wireless nodeBs. The nodeBs 408 provide wireless access points to a core network 404 for any number of mobile apparatuses. For illustrative purposes, three UEs 410 are shown in communication with the nodeBs 408. The downlink (DL), also called the forward link, refers to the communication link from a nodeB to a UE, and the uplink (UL), also called the reverse link, refers to the communication link from a UE to a nodeB.

The core network 404, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 404 supports circuit-switched services with a mobile switching center (MSC) 412 and a gateway MSC (GMSC) 414. One or more RNCs, such as the RNC 406, may be connected to the MSC 412. The MSC 412 is an apparatus that controls call setup, call routing, and UE mobility functions. The MSC 412 also includes a visitor location register (VLR) (not shown) that contains subscriber-related information for the duration that a UE is in the coverage area of the MSC 412. The GMSC 414 provides a gateway through the MSC 412 for the UE to access a circuit-switched network 416. The GMSC 414 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 414 queries the HLR to determine the UE's location and forwards the call to the particular MSC serving that location.

The core network 404 also supports packet-data services with a serving GPRS support node (SGSN) 418 and a gateway GPRS support node (GGSN) 420. General packet radio service (GPRS) is designed to provide packet-data services at speeds higher than those available with standard GSM circuit-switched data services. The GGSN 420 provides a connection for the RAN 402 to a packet-based network 422. The packet-based network 422 may be the Internet, a private data network, or some other suitable packet-based network. The primary function of the GGSN 420 is to provide the UEs 410 with packet-based network connectivity. Data packets are transferred between the GGSN 420 and the UEs 410 through the SGSN 418, which performs primarily the same functions in the packet-based domain as the MSC 412 performs in the circuit-switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a nodeB 408 and a UE 410, but divides uplink and downlink transmissions into different time slots in the carrier.

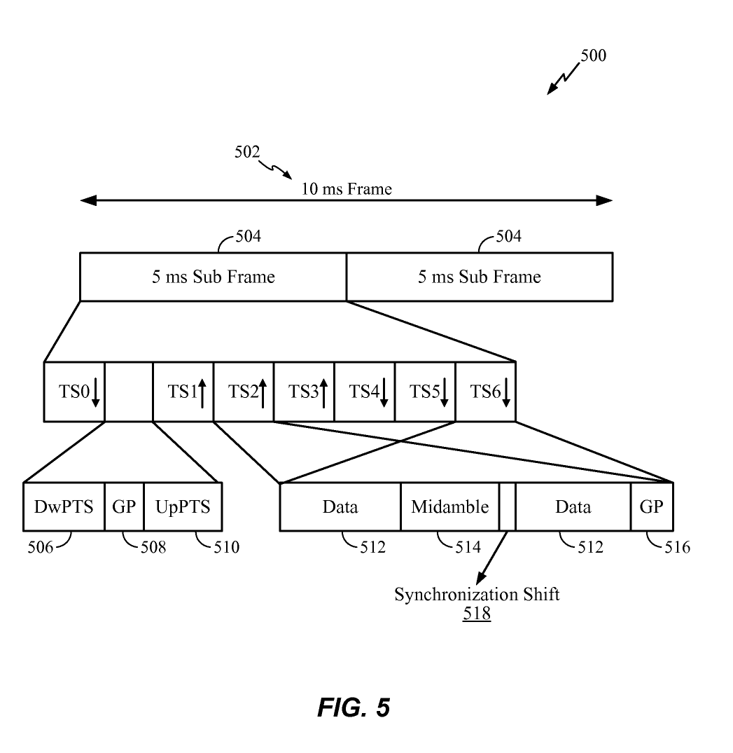

FIG. 5 shows a frame structure 500 for a TD-SCDMA carrier. The TD-SCDMA carrier, as illustrated, has a frame 502 that is 10 ms in length. The chip rate in TD-SCDMA is 1.28 Mcps. The frame 502 has two 5 ms subframes 504, and each of the subframes 504 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 506, a guard period (GP) 508, and an uplink pilot time slot (UpPTS) 510 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 512 (each with a length of 352 chips) separated by a midamble 514 (with a length of 144 chips) and followed by a guard period (GP) 516 (with a length of 16 chips). The midamble 514 may be used for features, such as channel estimation, while the guard period 516 may be used to avoid inter-burst interference. Also transmitted in the data portion is some Layer 1 control information, including synchronization shift (SS) bits 518. Synchronization shift bits 518 only appear in the second part of the data portion. The synchronization shift bits 518 immediately following the midamble can indicate three cases: decrease shift, increase shift, or do nothing in the upload transmit timing. The positions of the synchronization shift bits 518 are not generally used during uplink communications.

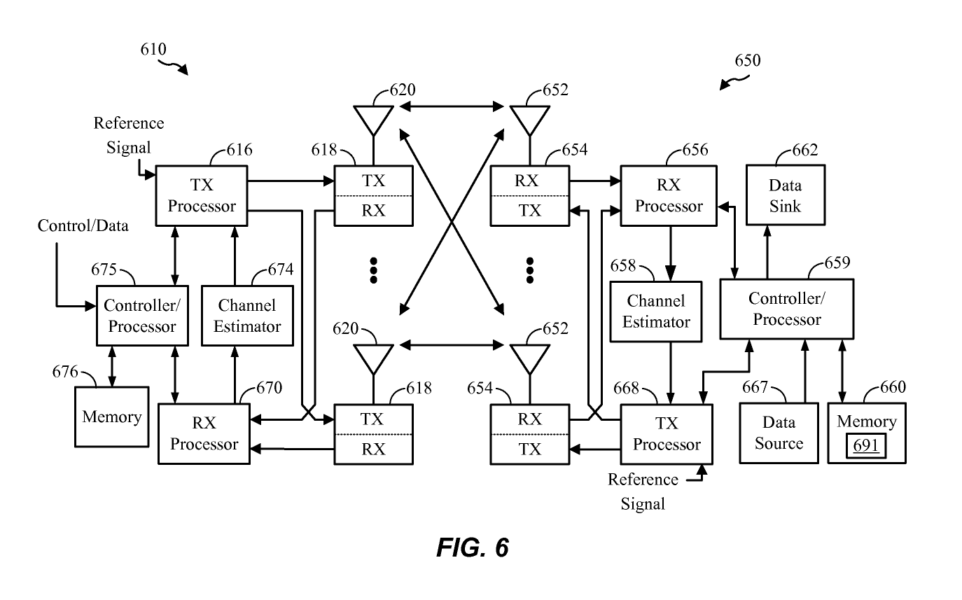

FIG. 6 is a block diagram of a base station (e.g., eNB or nodeB) 610 in communication with a UE 650 in an access network. In the downlink, upper layer packets from the core network are provided to a controller/processor 675. The controller/processor 675 implements the functionality of the L2 layer. In the downlink, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The TX processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter (TX) 618. Each transmitter (TX) 618 modulates a radio frequency (RF) carrier with a respective spatial stream for transmission.

At the UE 650, each receiver (RX) 654 receives a signal through its respective antenna 652. Each receiver (RX) 654 recovers information modulated onto an RF carrier and provides the information to the receiver (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the base station 610. These soft decisions may be based on channel estimates computed by the channel estimator 658. The soft decisions are then decoded and deinterleaved to recover the data and control signals that were originally transmitted by the base station 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the uplink, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the uplink, a data source 667 is used to provide upper layer packets to the controller/processor 659. The data source 667 represents all protocol layers above the L2 layer. Similar to the functionality described in connection with the downlink transmission by the base station 610, the controller/processor 659 implements the L2 layer for the user plane and the control plane by providing header compression, ciphering, packet segmentation and reordering, and multiplexing between logical and transport channels based on radio resource allocations by the base station 610. The controller/processor 659 is also responsible for HARQ operations, retransmission of lost packets, and signaling to the base station 610.

Channel estimates derived by a channel estimator 658 from a reference signal or feedback transmitted by the base station 610 may be used by the TX processor 668 to select the appropriate coding and modulation schemes, and to facilitate spatial processing. The spatial streams generated by the TX processor 668 are provided to different antenna 652 via separate transmitters (TX) 654. Each transmitter (TX) 654 modulates an RF carrier with a respective spatial stream for transmission.

The uplink transmission is processed at the base station 610 in a manner similar to that described in connection with the receiver function at the UE 650. Each receiver (RX) 618 receives a signal through its respective antenna 620. Each receiver (RX) 618 recovers information modulated onto an RF carrier and provides the information to a RX processor 670. The RX processor 670 may implement the L1 layer.

The controller/processor 675 implements the L2 layer. The controller/processor 675 and 659 can be associated with memories 676 and 660, respectively that store program codes and data. For example, the controller/processors 675 and 659 may provide various functions including timing, peripheral interfaces, voltage regulation, power management, and other control functions. The memories 676 and 660 may be referred to as a computer-readable media. For example, the memory 660 of the UE 650 may store a wireless communication module 691 which, when executed by the controller/processor 659, configures the UE 650 to schedule tune aways according to aspects of the present disclosure.

In the uplink, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

### Carrier Aggregation

In LTE, the UEs use spectrum in 20 Mhz bandwidths allocated in a carrier aggregation of up to a total of 100 Mhz (5 component carriers) used for transmission in each direction. Generally, less traffic is transmitted on the uplink than the downlink, so the uplink spectrum allocation may be smaller than the downlink allocation. For example, if 20 Mhz is assigned to the uplink, the downlink may be assigned 100 Mhz. These asymmetric FDD assignments conserve spectrum and are a good fit for the typically asymmetric bandwidth utilization by broadband subscribers.

Two types of carrier aggregation (CA) methods include continuous CA and non-continuous CA. Continuous CA occurs when multiple available component carriers are adjacent to each other. On the other hand, non-continuous CA occurs when multiple available component carriers are separated along the frequency band. Both non-continuous and continuous CA aggregate multiple LTE/component carriers to serve a single unit of a LTE UE.

Multiple radio frequency (RF) receiving units and multiple FFTs may be deployed with non-continuous CA in LTE configured UEs since the carriers are separated along the frequency band. Because non-continuous CA supports data transmissions over multiple separated carriers across a large frequency range, propagation path loss, Doppler shift and other radio channel characteristics may vary a lot at different frequency bands.

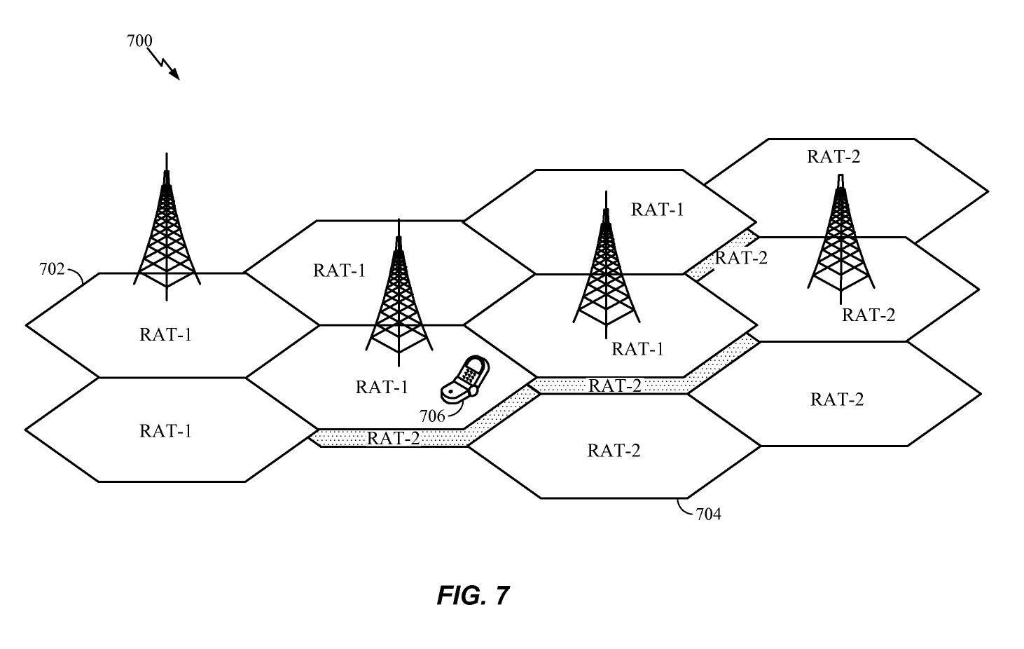

FIG. 7 illustrates a network having multiple types of radio access technologies (RATs). In one example, the geographical area 700 includes RAT-1 cells 702 and RAT-2 cells 704. In one example, the RAT-1 cells are 2G or 3G cells and the RAT-2 cells are LTE cells. However, those skilled in the art will appreciate that other types of radio access technologies may be utilized within the cells. A user equipment (UE) 706 may move from one cell, such as a RAT-1 cell 702, to another cell, such as a RAT-2 cell 704. The movement of the UE 706 may specify a handover or a cell reselection.

The handover or cell reselection may be performed when the UE moves from a coverage area of a first RAT to the coverage area of a second RAT, or vice versa. A handover or cell reselection may also be performed when there is a coverage hole or lack of coverage in one network or when there is traffic balancing between a first RAT and the second RAT networks. As part of that handover or cell reselection process, while in a connected mode with a first system (e.g., TD-SCDMA) a UE may be specified to perform a measurement of a neighboring cell (such as GSM cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The measurement may include a serving cell signal strength, such as a received signal code power (RSCP) for a pilot channel (e.g., primary common control physical channel (PCCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

A user equipment (UE) may include more than one subscriber identity module (SIM) or universal subscriber identity module (USIM). A UE with more than one SIM may be referred to as a multi-SIM device, and may include a dual-SIM device. In the present disclosure, a SIM may refer to a SIM or a USIM. Each SIM may also include a unique international mobile subscriber identity (IMSI) and service subscription information. Each SIM may be configured to operate in a particular radio access technology (RAT). Moreover, each SIM may have full phone features and be associated with a unique phone number. Therefore, the UE may use each SIM to send and receive phone calls. That is, the UE may simultaneously communicate via the phone numbers associated with each individual SIM. For example, a first SIM card can be associated for use in a City A and a second SIM card may be associated for use in a different City B to reduce roaming fees and long distance calling fees. Alternately, a first SIM card may be assigned for personal usage and a different SIM card may be assigned for work/business purposes. In another configuration, a first SIM card provides full phone features and a different SIM card is utilized mostly for data services.

Many multi-SIM devices support multi-SIM multi-standby operation using multiple radio frequency (RF) chains to transmit and receive communications. Other devices include only a single radio, shared among the different SIMs. An RF chain is a set of components used to communicate between the mobile device and the base station.

The UE may also be a multi-SIM multi-standby device, which means the UE is limited to connecting to one network at a time. A multi-SIM multi-standby device may also include a dual-SIM dual-standby device. In one example, a multi-SIM device includes a first SIM dedicated to operate in a first RAT using a first RF chain and a second SIM dedicated to operate in a second RAT using a second RF chain. Alternatively, the first SIM and the second SIM may share a same receive/transmit chain. As a result, communication on the first SIM may be suspended when the UE is communicating on the second SIM. In one illustrative example, the multi-SIM device includes a first SIM configured to operate in fourth generation (4G) radio access technology (RAT) (e.g., LTE) and a second SIM configured to operate in a second/third generation (2G/3G) RAT. The multi-SIM device may operate in other RATs known to those skilled in the art.

When a fourth generation (e.g., 4G) radio access technology subscription is in a radio resource control (RRC) connected mode without voice traffic, a single radio multi-SIM multi-standby UE (e.g., dual-subscriber identity module dual-standby device) supports tuning away from a connected RAT for various purposes, including neighbor cell measurement, etc. The UE may attempt to schedule the tune away to reduce the impact to ongoing communications. For example, the UE may tune away from the fourth generation RAT to the second/third generation (e.g., 2G/3G) RAT while trying to reduce the amount of interruption to the fourth generation connected mode operation. As an example of the UE tuning away to check a neighboring RAT's signal, a multi-SIM, multi-standby UE may periodically tune away from LTE (e.g. 4G) to perform one or more communication activities on TD-SCDMA or GSM. (e.g., 3G or 2G). The TD-SCDMA communication activities may include monitoring for a page, collecting broadcast control channel (BCCH) system information blocks (SIBs), performing cell reselection, etc. If a page is detected when the UE is tuned to TD-SCDMA, the UE suspends LTE operations and transitions to TD-SCDMA. When a page is not detected on the second/third generation RAT (e.g., GSM, TD-SCDMA), the UE tunes back or attempts to tune back to the fourth generation RAT (e.g., LTE) and attempts to recover the original operation of the fourth generation RAT.

A key area for multi-SIM multi-standby device improvement is to reduce the tuning away gap impact as much as possible, such as reducing tuning away gap length. However, the amount of improvement is constrained because of the hardware limitations and the cost consideration of devices.

### Tune Away Procedure Based on Tdd UL/DL Configuration

It has been observed that the same tuning away period (or gap) produces different throughput when the tune away period starts at different times. The different throughput for different start times is significant for time division duplex (TDD) long term evolution (LTE) where the tuning away gap has only a small number of uplink subframes (e.g., one or two uplink subframes), which may be the only uplink subframe(s) in a radio frame for some TDD uplink/downlink subframe configurations. In particular, the communications on a user equipment (UE) may be interrupted based on the start time of the tuning away gap. For example, downlink (DL) sub frames occurring during the tuning away gap cannot be used use for data transmission. In addition, some downlink subframes that occur outside of the tuning away gap cannot be used for data transmission, because HARQ feedback occurs within the tuning away gap. The unavailability of the downlink subframes may cause communication interruptions.

In one aspect of the disclosure, a user equipment (UE) determines when to start a tune away based on the current TDD uplink/downlink configuration. For example, the UE may be configured to delay the start of the tune away and to adaptively select the starting point of a tune away period based on the current TDD uplink/downlink configuration. Additionally, when determining when to start a tune away, the UE may consider other factors such as, but not limited to, the types of subframes in a current TDD uplink/downlink configuration, whether any of the types of subframes are designated for acknowledging previous received subframes; and how many subframes of a first type are associated with subframes of another type.

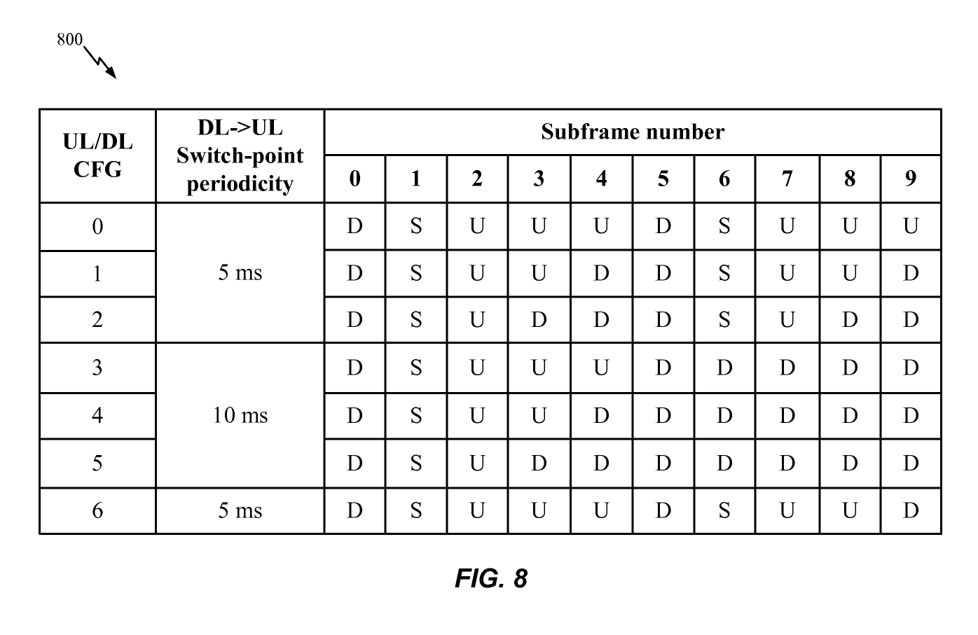

FIG. 8 illustrates a table 800 listing example TDD LTE uplink/downlink subframe configurations. The configurations has various subframe types including uplink, downlink and special subframes. In particular, in the table 800, “D” represents the subframes configured as downlink subframes, “U” indicates subframes configured as uplink subframes, and the special subframes (DwPTS+gap period+UpPTS) are denoted by “S.” Generally, the downlink/uplink configurations are based on the uplink/downlink traffic distribution. For example, a symmetric one-to-one ratio (1:1) downlink/uplink traffic distribution may use configuration 1. A downlink heavy traffic distribution (e.g., 2:1, 3:1, 7:2, 8:1) may use configurations 2, 3, 4 5. Further, an uplink heavy traffic distribution (1:3, 3:5) may use configurations 0, 6. The various uplink/downlink configurations determine the number of subframes allocated for uplink and downlink transmission in a given frame.

In one aspect, the UE determines when to start the tune away based on whether a first subframe type (e.g., uplink) is designated for acknowledgment (ACK) of data previously communicated on a plurality of second subframe types (e.g., downlink). The previously communicated data may include previously received and/or transmitted downlink data. In one example, the UE may determine, according to the TDD uplink/downlink configuration, whether a subframe is designated as an uplink subframe for acknowledgement (ACK) of previously received downlink subframe(s). If the uplink subframe is designated for ACK, the UE may determine to not to start a tune away, and may further determine to delay starting the tune away. If however, the next subframe is not designated for ACK, the UE may determine to proceed with the tune away. Additionally, the previously communicated data may be included in at least one component carrier.

Additionally, determining when to start the tune away may be based on how many subframe types are associated with a subframe type waiting for an acknowledgement. Further, in another aspect, determining when to start the tune away may be based on how many first subframe types are associated with a second subframe type. If too many downlink subframes are associated with the uplink subframe, the UE may determine not to start a tune away if it would conflict with the uplink subframe. In some TDD configurations, many subframes may be allocated for downlink transmissions while just a few (or one) sub frames are allocated for uplink transmission(s). When there are only a few (e.g., one or two) uplink subframes available, those frame are needed to send an acknowledgement for all the received downlink transmissions. For example, referring to FIG. 8, and in particular to the uplink/downlink configuration (UL/DL CFG) 5, there are many subframes allocated for downlink and only one subframe allocated for uplink. In one example, the UE receives four downlink subframes. Because the UE has only one uplink subframe available, the UE sends back acknowledgements (ACKs) for all four of the received downlink subframes in the single allocated uplink subframe. Accordingly, the UE cannot waste the uplink subframe by tuning away during the one available allocated uplink subframe because the UE would miss the opportunity to send the acknowledgement of the downlink subframes. If the UE were to tune away during the uplink subframe, then the acknowledgement would not be sent and the previous four downlink transmissions would be wasted (would have to be retransmitted due to lack of acknowledgment) and the throughput loss would be high.

In another example, the TDD uplink/downlink configuration 0 is utilized. This configuration has two downlink subframes and six uplink subframes. Because the UE has many uplink subframes available, the UE may determine to tune away during the uplink subframe, and the throughput loss would be small.

The UE may also determine to start the tune away based on the acknowledgment feedback mode, which includes a bundle mode and a multiplex mode. In the bundle mode, the UE may bundle acknowledgements for multiple downlink subframes into one uplink subframe. For example, in a TDD configuration having ten downlink subframes and one uplink subframe, if the UE is operating in bundle mode, then when the UE receives all the downlink subframes the UE will send one ACK in one subframe. However, if one downlink subframe fails, the UE will send one NACK (negative acknowledgement). In this example, the UE will not tune away when the acknowledgement feedback mode is in bundle mode because there will be high throughput loss.

By comparison, in the multiplex mode, the UE transmits an acknowledgement/negative acknowledgement (ACK/NACK) for each downlink subframe transmission the UE receives. For example, if the UE receives ten downlink subframe transmissions, the UE sends ten ACK/NACKs, one for each subframe received. In this example, when the UE is in a multiplex mode, the UE will tune away.

Additionally, the UE may also determine whether to start a tune away based on whether the tune away is a time unrestricted tune away or a time restricted tune away. A time unrestricted tune may include a tune away to capture/collect a repeated transmission. Examples of time unrestricted tune aways include, but are not limited to, system information collection (e.g., system information block collection), cell reselection or registration including location area update and routing area update. In comparison, a function such as monitoring paging is deemed a restricted tune away because the paging occurs at a specific time. Because there is a greater window of opportunity to capture functions occurring during the unrestricted tune away category, rescheduling the unrestricted tune away may have less impact (e.g., reduced communication interruption) on a first radio access technology (RAT) or first SIM communication.

In another aspect, the UE may determine when to start the tune away based on how many component carriers are associated with a first subframe type carrying an acknowledgement.

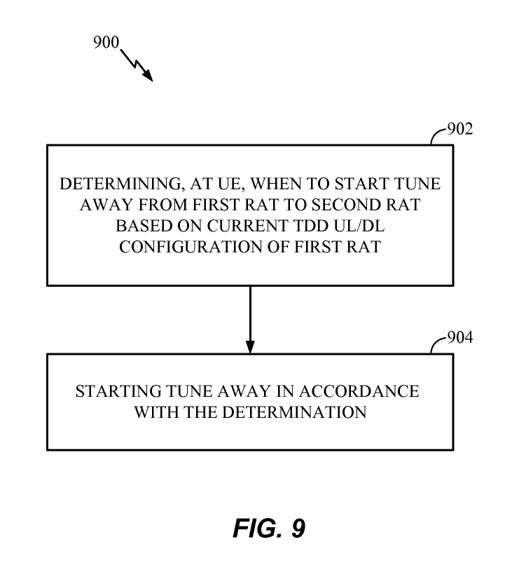

FIG. 9 shows a method 900 of wireless communication in a time division duplex (TDD) system in a multi-SIM (subscriber identity module) multi-standby UE (user equipment) according to one aspect of the disclosure. At block 902, a user equipment (UE) determines when to start a tune away from a first RAT (radio access technology) to a second RAT based on a current TDD uplink/downlink configuration of the first RAT. At block 904, the UE starts the tune away in accordance with the determination.

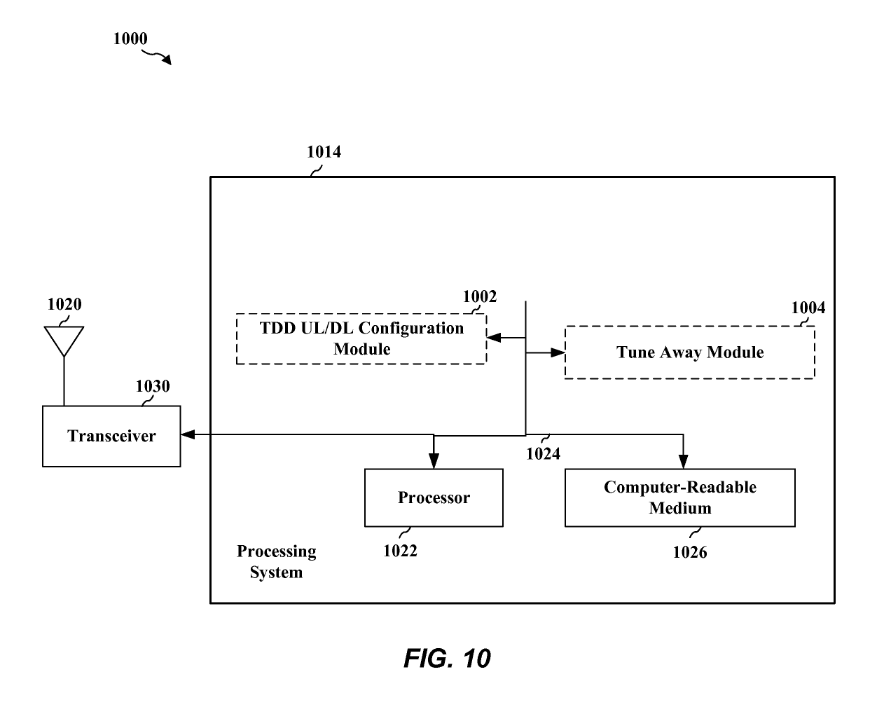

FIG. 10 is a diagram illustrating an example of a hardware implementation for an apparatus 1000 employing a processing system 1014. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware modules, represented by the processor 1022 the modules 1002, 1004, and the non-transitory computer-readable medium 1026. The bus 1024 may also link various other circuits such as timing sources, peripherals, voltage regulators, and power management circuits, which are well known in the art, and therefore, will not be described any further.

The apparatus includes a processing system 1014 coupled to a transceiver 1030. The transceiver 1030 is coupled to one or more antennas 1020. The transceiver 1030 enables communicating with various other apparatus over a transmission medium. The processing system 1014 includes a processor 1022 coupled to a non-transitory computer-readable medium 1026. The processor 1022 is responsible for general processing, including the execution of software stored on the computer-readable medium 1026. The software, when executed by the processor 1022, causes the processing system 1014 to perform the various functions described for any particular apparatus. The computer-readable medium 1026 may also be used for storing data that is manipulated by the processor 1022 when executing software.

The processing system 1014 includes a TDD UL/DL configuration module 1002 for determining, at the UE, when to start a tune away from a first RAT to a second RAT based on a current TDD uplink/downlink (UL/DL) configuration of the first RAT. The processing system 1014 also includes a tune away module 1004 for starting a tune away in accordance with the determination. The modules 1002 and 1004 may be software modules running in the processor 1022, resident/stored in the computer-readable medium 1026, one or more hardware modules coupled to the processor 1022, or some combination thereof The processing system 1014 may be a component of the UE 650 of FIG. 6 and may include the memory 660, and/or the controller/processor 659.

In one configuration, an apparatus such as a UE 650 is configured for wireless communication including means for determining In one aspect, the determining means may be the receive processor 656, the controller/processor 659, the memory 660, the wireless communication module 691, the TDD UL/DL configuration module 1002, and/or the processing system 1014 configured to perform the aforementioned means. In one configuration, the means functions correspond to the aforementioned structures. In another aspect, the aforementioned means may be a module or any apparatus configured to perform the functions recited by the aforementioned means.

The UE 650 is also configured to include means for starting a tune away. In one aspect, the starting means may include the antennas 652/1020, the receiver 654, the transceiver 1030, the receive processor 656, the controller/processor 659, the memory 660, the tune away module 1004, and/or the processing system 1014 configured to perform the functions recited by the starting means. In one configuration, the means and functions correspond to the aforementioned structures. In another aspect, the aforementioned means may be a module or any apparatus configured to perform the functions recited by the starting means.

The UE 650 is also configured to include means for delaying a tune away. In one aspect, the delaying means may include the antennas 652/1020, the receiver 654, the transceiver 1030, the receive processor 656, the controller/processor 659, the memory 660, the tune away module 1004, and/or the processing system 1014 configured to perform the functions recited by the delaying means. In one configuration, the means and functions correspond to the aforementioned structures. In another aspect, the aforementioned means may be a module or any apparatus configured to perform the functions recited by the delaying means.

Several aspects of a telecommunications system has been presented with reference to LTE, TD-SCDMA and GSM systems. As those skilled in the art will readily appreciate, various aspects described throughout this disclosure may be extended to other telecommunication systems, network architectures and communication standards, including those with high throughput and low latency such as 4G systems, 5G systems and beyond. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication in a time division duplex (TDD) system in a multi-SIM (subscriber identity module) multi-standby, single receiver UE (user equipment), comprising:
determining, at the UE, when to start a tune away from a first RAT (radio access technology) to a second RAT based, at least in part, on a current TDD uplink/downlink configuration of the first RAT.

2. The method of claim 1, further comprising determining when to start the tune away is based, at least in part, on whether a first subframe type is designated for acknowledging data previously communicated on a plurality of second subframe types.

3. The method of claim 2, further comprising delaying the tune away until after the first subframe type when downlink data communicated on the plurality of second subframe types is awaiting acknowledgment.

4. The method of claim 1, further comprising determining when to start the tune away based, at least in part, on how many first subframe types are associated with a first subframe type carrying an acknowledgment.

5. The method of claim 1, further comprising determining when to start the tune away based, at least in part, on how many component carriers are associated with a first subframe type when it is carrying acknowledgment.

6. The method of claim 1, further comprising determining when to start the tune away based, at least in part, on an acknowledgment feedback mode.

7. The method of claim 1, in which the tune away comprises a time unrestricted tune away.

8. An apparatus for wireless communication in a time division duplex (TDD) system in a multi-SIM (subscriber identity module) multi-standby, single receiver UE (user equipment), comprising:
means for determining, at the apparatus, when to start a tune away from a first RAT (radio access technology) to a second RAT based, at least in part, on a current TDD uplink/downlink configuration of the first RAT; and
means for starting the tune away in accordance with the determining.

9. The apparatus of claim 8, in which the means for determining when to start the tune away is based, at least in part, on whether a first subframe type is designated for acknowledging data previously communicated on a plurality of second subframe types.

10. The apparatus of claim 9, further comprising means for delaying the tune away until after the first subframe type when downlink data communicated on the plurality of second subframe types is awaiting acknowledgment.

11. The apparatus of claim 8, in which the means for determining when to start the tune away is based, at least in part, on how many first subframe types are associated with a first subframe type carrying an acknowledgment.

12. The apparatus of claim 8, in which the means for determining when to start the tune away is based, at least in part, on how many component carriers are associated with a first subframe type carrying acknowledgment.

13. The apparatus of claim 8, in which the for determining when to start the tune away is based, at least in part, on an acknowledgment feedback mode.

14. The apparatus of claim 8, in which the tune away comprises a time unrestricted tune away.

15. An apparatus for wireless communication in a time division duplex (TDD) system in a multi-SIM (subscriber identity module) multi-standby, single receiver UE (user equipment), comprising:
a memory;
a transceiver configured for wireless communication; and
at least one processor coupled to the memory, the at least one processor being configured:
to determine, at the apparatus, when to start a tune away from a first RAT (radio access technology) to a second RAT based, at least in part, on a current TDD uplink/downlink configuration of the first RAT.

16. The apparatus of claim 15, in which the at least one processor is further configured to determine when to start the tune away based, at least in part, on whether a first subframe type is designated for acknowledging data previously communicated on a plurality of second subframe types.

17. The apparatus of claim 16, in which the at least one processor is further configured to delay starting the tune away until after the first subframe type when downlink data communicated on the plurality of second subframe types is awaiting acknowledgment.

18. The apparatus of claim 15, in which the at least one processor is further configured to determine when to start the tune away based, at least in part, on how many first subframe types are associated with a first subframe type carrying an acknowledgment.

19. The apparatus of claim 15, in which the at least one processor is further configured to determine when to start the tune away based, at least in part, on how many component carriers are associated with a first subframe type carrying acknowledgment.

20. The apparatus of claim 15, in which the at least one processor is further configured to determine when to start the tune away based, at least in part, on an acknowledgment feedback mode.

21. The apparatus of claim 15, in which the tune away comprises a time unrestricted tune away.

22. A computer program product for wireless communication in a time division duplex (TDD) system in a multi-SIM (subscriber identity module) multi-standby, single receiver UE (user equipment), comprising:
a non-transitory computer-readable medium having non-transitory program code recorded thereon, the program code comprising:
program code to determine, at the UE, when to start a tune away from a first RAT (radio access technology) to a second RAT based, at least in part, on a current TDD uplink/downlink configuration of the first RAT.

23. The computer program product of claim 22, in which the program code is further configured to determine when to start the tune away based, at least in part, on whether a first subframe type is designated for acknowledging data previously communicated on a plurality of second subframe types.

24. The computer program product of claim 23, in which the program code further comprises:
program code to delay starting the tune away until after the first subframe type when downlink data communicated on the plurality of second subframe types is awaiting acknowledgment.

25. The computer program product of claim 22, in which program code is further configured to determine when to start the tune away based, at least in part, on how many first subframe types are associated with a first subframe type carrying an acknowledgment.

26. The computer program product of claim 22, in which the program code is further configured to determine when to start the tune away based, at least in part, on how many component carriers are associated with a first subframe type carrying acknowledgment.

27. The computer program product of claim 22, in which the program code is further configured to determine when to start the tune away based, at least in part, on an acknowledgment feedback mode.

28. The computer program product of claim 22, in which the tune away comprises a time unrestricted tune away.
